(19) United States
(12) Patent Application Publication
(10) Pub. No.: US 2026/0035050 A1
(43) Pub. Date: Feb. 5, 2026

(54) CLIPLESS BICYCLE PEDAL ASSEMBLY

(71) Applicant: Casually Clipless LLC, Crystal Lake, IL (US)

(72) Inventors: Braeden Harrell, Crystal Lake, IL (US); Maximus Pignotti, Mokena, IL (US); Jennifer Schmidt, Cedar Rapids, IA (US)

(73) Assignee: Casually Clipless LLC, Crystal Lake, IL (US)

(21) Appl. No.: 19/289,818

(22) Filed: Aug. 4, 2025

Related U.S. Application Data
(60) Provisional application No. 63/679,155, filed on Aug. 4, 2024.

(51) Int. Cl. B62M 3/08

(52) U.S. Cl. CPC B62M 3/086

(57) ABSTRACT

A clipless pedal assembly having a cleat configured for attachment to a cycling shoe and a pedal insert configured for attachment to a bike pedal. The cleat is configured to selectively attach to the pedal insert while a cyclist is pedaling the bike. The cleat includes cleat tabs and the pedal insert includes hub tabs. The hub tabs are retained by the cleat tabs to aid in keeping the cleat engaged with the pedal insert. There is no torsional spring force keeping the two components engaged so the cleat can rotate freely within the pedal insert up to a predetermined angle of rotation in either the clockwise or counterclockwise direction. Upon reaching the predetermined angle of rotation the cleat tabs to misalign with the hub tabs allowing the cleat to be disengaged from pedal insert without having to overcome any spring force.

### FIELD OF THE INVENTION

The present disclosure comprises a clipless bicycle pedal assembly configured to secure a cyclist's shoe to a bicycle pedal. More particularly, the present disclosure comprises a pedal insert configured to attach to a bicycle pedal and a cleat configured to attach to a cycling shoe. The pedal insert and cleat are configured to be selectively engaged with and disengaged from each other. Once engaged, the cleat may rotate within the pedal insert up to a predetermined maximum release angle while still maintaining a strong, sturdy connection between the components. Upon rotating the cleat beyond the predetermined release angle, the cleat may be released from the pedal without having to overcome any spring force.

### BACKGROUND

This application is based upon U.S. Provisional Application Ser. No. 63/679,155 filed Aug. 4, 2024, the complete disclosure of which is hereby expressly incorporated by this reference.

Cycling is an increasingly popular sport and hobby for many individuals around the globe. Many of these individuals utilize clipless bicycle pedals because of the added benefits provided by these types of pedals. Clipless pedals allow the cyclist to pull up on the pedal as well as push down on the pedal, activating more muscle groups and delivering more power throughout the entire pedal stroke. Being clipped into the pedals keeps the cyclist's feet securely in place on the pedal, reducing the chance of slipping off the pedal. This is especially important on rough terrain, sprints, and technical sections of a bicycle route. Clipless pedals also give cyclists a more connected feel to the bike, which improves handling.

Clipless pedals come with disadvantages which can sometimes result in frustration, embarrassment, or injury of its users. Beginner cyclists often experience difficulty engaging and disengaging the cleat mechanism (on the shoe) with the pedal, which can result in loss of balance and falling over at low speeds. This issue stems from the need for a strong foot rotation to overcome the spring force on the pedal's locking mechanism to release the cleat/shoe from the pedal. If the cyclist does not release their foot from the pedal before stopping, they could fall over with their feet still “clipped in” to the pedal.

Cyclists who are new to clipless pedals are often advised to begin with the lowest release tension setting to help minimize the risk of unintended falls during disengagement. Among beginner, casual, and older cyclists, there is a strong preference for mechanisms which allow for release with minimal resistance, eliminating the need to overcome a significant spring force threshold. However, since it takes less force to release from the pedal at lower release tension settings, there is a greater likelihood the cyclist may unintentionally release from the pedal during a ride which can also lead to frustration, embarrassment, or injury. Beginner cyclists may not be as comfortable on their bike which can deter them from using high tension clipless pedals due to the associated learning curve. Casual, weekend cyclists often benefit greatly from clipless pedals but don't want the added risk of injury that comes with current clipless pedals on the market. As people age, they lose muscle strength in their legs. Reduced leg muscle strength can greatly lower the amount of rotational force a cyclist can provide to disengage from a clipless pedal, increasing risk for injury while using clipless pedals. There is therefore a need in the cycling market for a clipless pedal having a release mechanism securely connecting the shoe to the pedal during cycling but requiring minimal force to release the shoe from the pedal when the cyclist desires disengagement.

One existing clipless pedal is described in U.S. Pat. No. 5,546,829A (Bryne). Bryne generally discloses a clipless pedal system having a cleat configured to be selectively engaged with a pedal. The cleat includes a spring mechanism on the main cleat body that leaves it exposed to debris and wear as it sits on the underside of a cycling shoe. Damage over time to this vital spring component will lead to failure and cause the system to not engage. Further, during the disengaging release, the cyclist must rotate to disengage and then lift their foot up and off of the pedal before planting their foot on the ground. It can be difficult for some cyclists to perform both of these motions while maintaining stability on the bike, especially at lower speeds. Lastly, the alignment of the pedal and cleat prior to and during engagement requires high accuracy of the blind movement of the cleat onto the pedal. There is a lack of assistance from the system components to guide this engaging motion.

There is therefore a need for a clipless pedal assembly that overcomes these and other drawbacks in the prior art while preserving the functional advantages offered by clipless bicycle pedals assemblies.

### SUMMARY

One object of the present disclosure is to provide a clipless pedal assembly that allows for stability, increased efficiency, and proper foot placement without sacrificing safety and ease of use.

Another object of the present invention is to provide a compatible cleat and pedal portion that together create the clipless pedal assembly for ease of engagement and disengage with minimal force.

Another object of the present disclosure is to provide a clipless pedal assembly having a pedal insert configured to be attached to a bike pedal and a cleat configured to be attached to a cycling shoe, wherein the cleat and the pedal insert have an engaged position and a disengaged position and moving from the engaged position to the disengaged position does not require overcoming any spring force.

Another object of the present disclosure is to provide a clipless pedal assembly configured to attach to a standard flat bike pedal.

Another object of the present disclosure is to provide a free float or increase in rotational angular mobility of the foot on the pedal when engaged to reduce the risk of leg pain or injury.

Another object of the present disclosure is to provide a clipless pedal assembly having a ramp assembly for guiding the users foot upward away from the pedal when disengaging as to mitigate how much force and manual effort is needed to safely disengage the mechanism and move the foot upward away from the pedal.

One embodiment of the present disclosure relates to a clipless bicycle pedal assembly comprising a pedal insert and a cleat. The clipless pedal assembly can be used for all types of biking including, but not limited to, mountain, road, hybrid, and indoor. In one embodiment the pedal insert is configured to be attached to a bike pedal and the cleat is configured to be attached to a cycling shoe. In other embodiments the location of the two components is reversed. The cleat is configured to be releasably attached to the pedal insert so the components have an engaged position wherein the cleat is attached to the pedal insert and a disengaged position wherein the cleat is not attached to the pedal insert. In moving the components to the engaged position, the cleat slides forward, utilizing a cleat guide rail, longitudinally across the top of the pedal insert. The cleat head depresses a latch that is biased in an extended position. Once the cleat is moved beyond the latch, the latch moves back to the extended position which secures the cleat head in the pedal insert slot, so it remains in place, eliminating significant lateral or longitudinal movement of the components with a singular means of engagement. Upon engagement, cleat tabs on the underside of the cleat are secured under the corresponding hub tabs on the pedal which fit in the cleat tab slot and lock the cleat in place preventing the cleat from lifting upward off of the pedal. Disengagement is achieved through a rotational motion to misalign the cleat tab from the pedal insert tabs and allowing separation of the cleat from the pedal insert. Due to the alignment of the components driving their engagement there is no need to overcome a spring force during disengagement, just rotation of the components relative to each other until the hub tabs are no longer retained in the cleat tab slot by the cleat tabs.

Another embodiment of the clipless bicycle pedal assembly further comprises a release ramp interface. This interface consists of opposing angled ramps, one on the pedal hub and one on the cleat head. While the cleat and the pedal insert are in their engaged position, these ramps complement each other or do not contact each other. However, as the cleat and the pedal insert are rotated toward their disengaged position, the opposing ramps come into contact causing them to shear across each other to move the cleat upward and away from the pedal insert to assist in the release of the cleat from the pedal insert. This motion guides the cyclist's foot upward and away from the pedal into a plant position wherein the cyclist is ready to plant his/her foot on the ground.

In another embodiment of the clipless bicycle pedal assembly, the pedal insert is configured to be attached to both sides of the pedal to allow for the cleat to be engaged to either side of the pedal.

Another embodiment of the invention relates to a method of operating one or more of the embodiments of the clipless bicycle pedal assembly described above. The method comprises moving the cleat and the pedal insert between an engaged position wherein the cleat is attached to the pedal insert and a disengaged position wherein the cleat is not attached to the pedal insert. To move the components from the disengaged position to the engaged position, the cleat slides forward, across the top of either pedal mechanism, the cleat head depressing the latch that then pops up as the cleat fully clears it. The cleat head sits between the now upright latch and the pedal hub, securing the interface, eliminating independent lateral or longitudinal movement of the components. Upon this engagement, the tabs on the underside of the cleat align beneath corresponding tabs on the pedal, the tabs on the pedal sitting in the cleat tab slot, locking the cleat in place vertically. To move the components from the engaged position to the disengaged position the cleat is rotated either clockwise or counter-clockwise relative to the pedal insert until the predetermined release angle is reached. Any rotation at or beyond this predetermined release angle allows disengagement of the components because the rotation offsets the cleat tabs from the hub tabs so they are no longer overlapping, and the hub tabs do not sit in their cleat tab slot. At the same time, the cleat head rotates so that it no longer sits between the latch and hub, rather moving towards either side of the hub where there are release ramps. The cleat and pedal release ramps come into contact, shearing across each other, pushing the cleat up and off of the pedal.

The clipless pedal assembly as described above is configured to work with a latch and pedal insert hub as a pair resulting in three means of engagement on the pedal portion. The cleat has two static engagement means, the cleat head and cleat tabs. The latch that engages with the cleat head is to be on the pedal portion, which avoids debris and dirt that otherwise would be on the cleat portion while the cyclist walks. The latch also provides greater structural support, backed by the main body of the pedal insert while keeping the cleat attachment lighter and slimmer. With the pedal insert hub and latch combining as the pedal portion, the pedal insert hub encounters less force and contact over time, causing less wear on the latch spring as the cleat head takes that role. The pedal hub remaining on the pedal portion keeps it from damage over time as it would be if the component were swapped and was connected to the bottom side of the cycling shoe. If the hub were on the shoe, hub tabs would be main points of contact both during engagement with the cleat and while the user is walking around, leading to increased risk of failure over a shorter period of time. The cleat is optimal without the extra weight and risk of failure with the latch spring attached to it; the pedal is optimal with the latch spring as it protects the latch spring and pedal insert slot from being clogged with dirt and debris; the pedal tabs and the latch spring are optimal on the same side as they sit together, with a pedal insert slot as wide as the cleat engagement chamfer and cleat head, and provide said cleat head with supportive engagement, which helps keep the cleat head secure during engagement and the cleat only needing two forms of engagement.

### BRIEF DESCRIPTION OF THE DRAWINGS

Understanding the present disclosure can be facilitated by, but is not limited to, the following detailed description of the preferred embodiments of the invention in conjunction with the accompanying drawings.

FIG. 1A is an exploded view of the clipless pedal assembly.

FIG. 1B is a perspective view of clipless pedal assembly showing the pedal insert engaged with the cleat.

FIG. 1C is a cross-sectional view of the clipless pedal assembly showing the pedal insert with the cleat about to begin engagement.

FIG. 1D is a cross-sectional view of the clipless pedal assembly showing the pedal insert partially engaged with the cleat.

FIG. 1E is a cross-sectional view of the clipless pedal assembly showing the pedal insert fully engaged with the cleat.

FIG. 2A is a bottom view of the cleat.

FIG. 2B is a rear view of the cleat.

FIG. 2C is a side cross-section view of the cleat.

FIG. 3A is a bottom view of the cleat showing the hub tab interface in the engaged position.

FIG. 3B is a rear view of the cleat and hub tab interface in the engaged position.

FIG. 3C is a bottom view of the cleat and hub tab interface in the disengaged position.

FIG. 4A is a side perspective view of the pedal insert ramp and cleat ramp at an engaged position of the cleat in the pedal insert.

FIG. 4B is a side perspective view of the pedal insert ramp and cleat ramp at a disengaged position of the cleat in the pedal insert.

FIG. 5A is a side view of the latch and latch spring.

FIG. 5B is a front view of the latch and latch spring.

### DETAILED DESCRIPTION

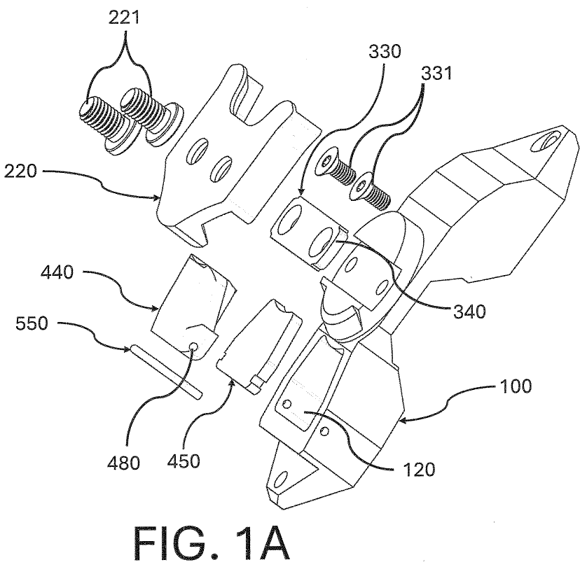

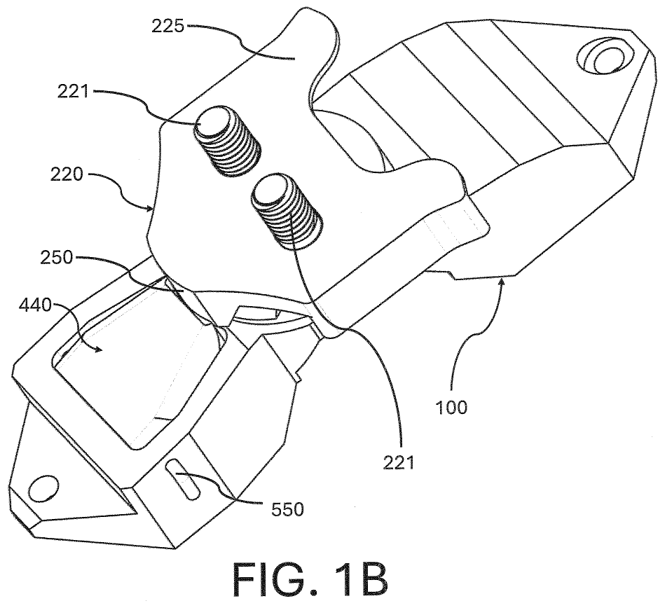

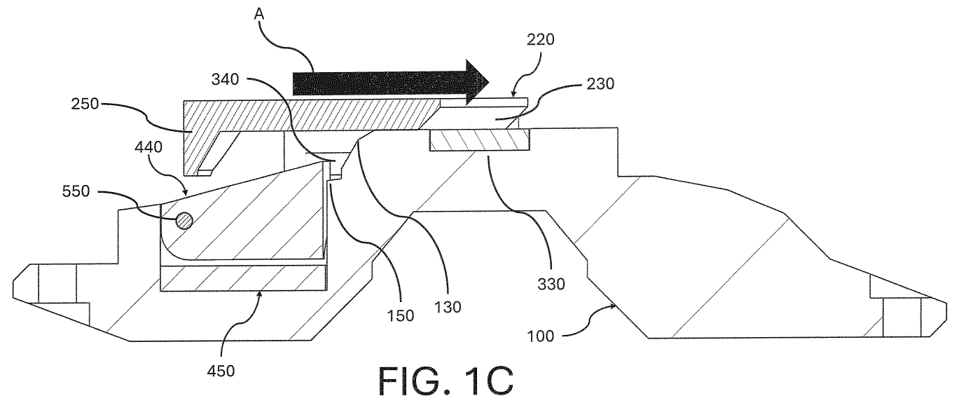

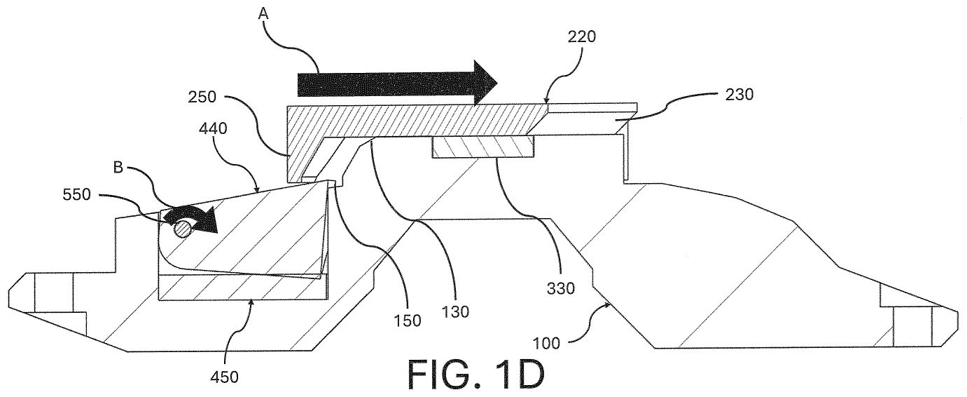

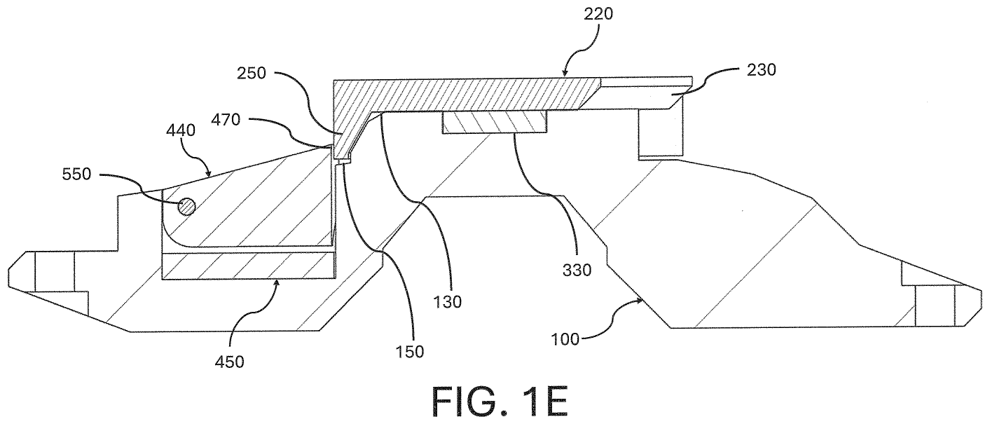

Embodiments of the present disclosure generally relate to a clipless bicycle pedal assembly comprising a pedal insert 100 and a cleat 220. In one embodiment the pedal insert 100 is configured to be attached to a pedal and the cleat 220 is configured to be attached to a cyclist's shoe. In other embodiments the pedal insert 100 is configured to be attached to a cyclist's shoe and the cleat 220 is configured to be attached to a pedal. For convenience, only the former embodiment is shown and described. As used herein, directional terms such as front, back, up, down, vertical, and horizontal are with respect to FIG. 1E (where front is to the right-hand side of the figure and back is to the left-hand side of the figure).

FIGS. 1A, 1B, 1C, 1D, and 1E illustrate an embodiment of the clipless pedal assembly. The pedal insert 100 comprises a latch 440, a latch spring 450, and a hub 330 configured to sit within a bike pedal to engage with the cleat 220. Latch 440 and latch spring 450 sit within pedal insert blind opening 120 within pedal insert 100. An elongated member such as rod 550 is slotted thru pedal insert blind opening 120 and latch opening 480 keeping latch 440 secured and in place while allowing rotation of the latch 440 around the rod 550. Latch spring 450 is engaged with the latch 440 and is movable between a first position and a second position. The latch spring 450 is biased in the first position. The latch spring 450 is positioned between the latch 440 and the bottom of pedal insert blind opening 120. When latch 440 experiences pressure pushing it down, latch 440 rotates about rod 550 (in the direction of arrow B in FIG. 1D) compressing latch spring 450 to its second/compressed position causing latch 440 to move into the pedal insert blind opening 120 as in FIG. 1D. When latch 440 experiences no pressure, latch spring 450 moves toward its first position urging the latch 440 back up to its rest position. In the latch 440 rest position, latch 440 protrudes up from pedal insert 100 near hub 330. Hub 330 remains stationary as the main contact between pedal insert 100 and cleat 220, sitting between the body of cleat 220 and cleat tabs 240 when fully engaged as in FIG. 1E. Hub 330 sits within a pedal insert recess 110 of pedal insert 100, and is fixed in place with two hub tab screws 331. The width of hub 330 allows for a predetermined maximum rotation of the foot before the cleat 220 and hub 330 becomes disengaged (as described further below). Cleat 220 is configured to be attached to the recess in the bottom of a biking shoe by two fasteners 221 such as cleat screws. When cleat 220 is secured to a shoe, cleat head 450 is positioned closest to the heel and the flat side sits along the sole of the shoe. When fasteners 221 are fully secured into a shoe with cleat 220, the fasteners 221 sit within a recession therefore they do not interfere with the engagement of the cleat 220 with the pedal insert 100.

FIGS. 1C to 1E display sequential cross-sectional views as the pedal insert 100 and the cleat 220 move from a disengaged position to an engaged position. To engage the cleat 220 with the pedal insert 100, cleat head 250 is configured to slide longitudinally across the top of latch 440 (in the direction of arrow A), compressing latch spring 450. As cleat 220 is sliding longitudinally forward, cleat engagement chamfer 230 interfaces with pedal insert chamfer 130 to guide cleat 220 into engagement with hub 330. Pedal insert chamfer 130 catches onto cleat engagement chamfer 230, directing it onto the flat surface of the hub 330. The interaction between the chamfers 130, 230 allows for much easier engagement of cleat 220, and help prevent cleat engagement chamfer 230 from getting stuck on any portion of pedal insert 100 prior to engaging with hub 330. In addition, the chamfers 130, 230 on cleat 220 and pedal insert 100 provide the cyclist with feedback as they engage their foot, providing a more confident engagement process.

The cleat 220 and the cleat guide rail 260 touches the hub tabs 340 to center the cleat 220 on the pedal insert 100. Then, cleat tabs 340 are guided underneath the hub tabs 340 and are received within cleat tab slot 245. The cleat tab slots 245 are one or more recessed opening between the cleat tabs 240 and an opposing surface of the cleat 220. Once cleat head 250 clears the latch head 470, the latch spring 450 moves the latch 440 back to its rest position as shown in FIG. 1E. The cleat 220 is fully engaged once the cleat head 250 is in the pedal insert slot 150 and cleat tabs 240 and received by the cleat tab slots 245. In the engaged position the cleat 220 is prevented from any significant movement relative to the pedal insert 100 in the forward/backward (longitudinal) direction as well as vertically and horizontally. Forward/Backward movement refers to moving towards the front or rear of the bike. Vertical movement refers to the ability to lift cleat 220 upward off pedal insert 100. Horizontal movement refers to cleat progression toward the bike crank or away from the bike. To prevent forward/backward movement, the cleat head 250 is pinned in the pedal insert slot 150 between the pedal insert chamfer 130 and the latch head 470. The overlap of cleat tabs 240 and hub tabs 340 prevent vertical movement. The width of the cleat guide rails wall 260 and the side of hub tabs 340 prevent significant horizontal movement. As discussed in more detail below, a predetermined amount of rotational movement of the cleat 220 relative to the pedal insert 100 is allowed.

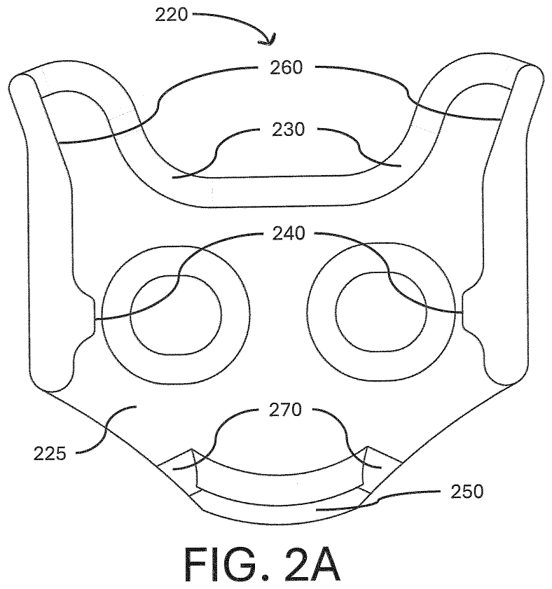

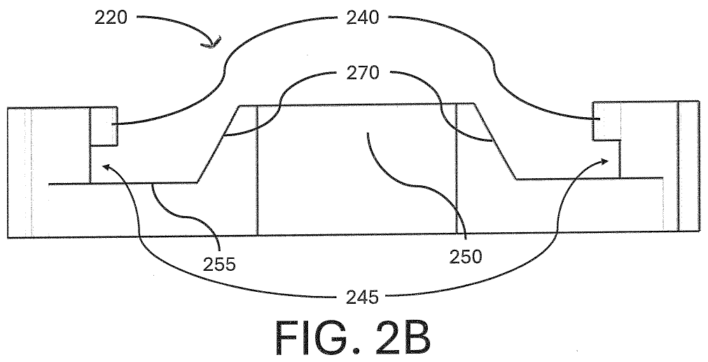

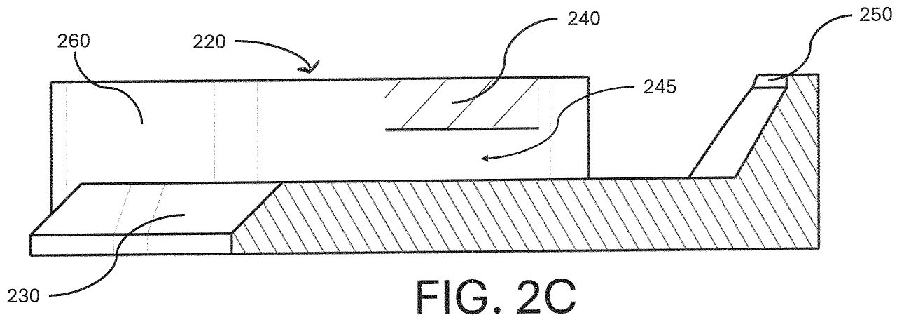

FIGS. 2A, 2B, and 2C show the cleat 220. The cleat 220 comprises a cleat main body 225, a cleat head 250, cleat tabs 240, and cleat tab slot 245. In some embodiments the fastener openings on cleat 220 are wider and more oval shaped compared to the cleat fasteners 221 that reside within them for attachment to a cycling shoe and to provide room for adjustment within the recess on the bottom sole of the shoe. The width of cleat 220 is designed to fit universally with a cycling shoe without sticking out from the bottom of the recessed section of the sole when riding with flat pedals or walking. In some embodiments the cleat 220 resembles the shape of a horseshoe to allow for structural support of high contact parts such as cleat tabs 240 and cleat head 450 that can often come into contact with cleat 220 while walking as they are attached to the sole of the shoe or while riding with a flat pedal configuration. In some embodiments the width of cleat guide rails 260 is slightly wider than the width of the hub 240. Cleat tabs 240 are offset from the base of cleat 220 slightly larger than the thickness of the hub 330 to interface smoothly when engaged, allowing for minimal vertical movement as well as friction.

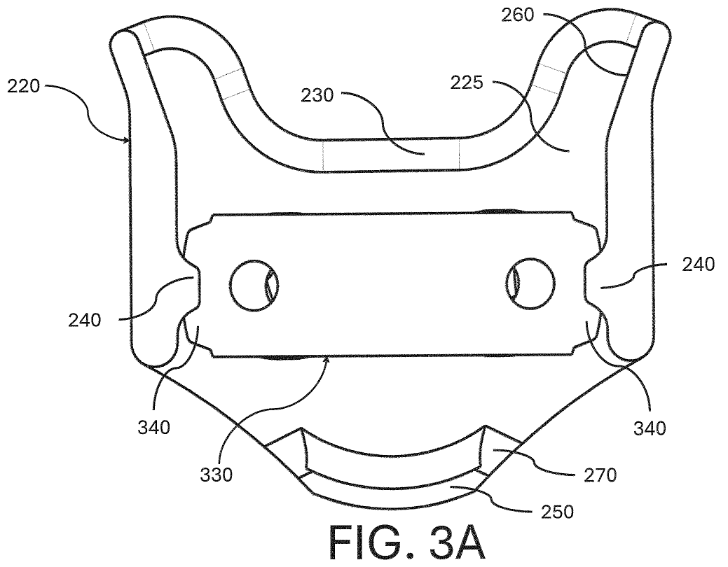

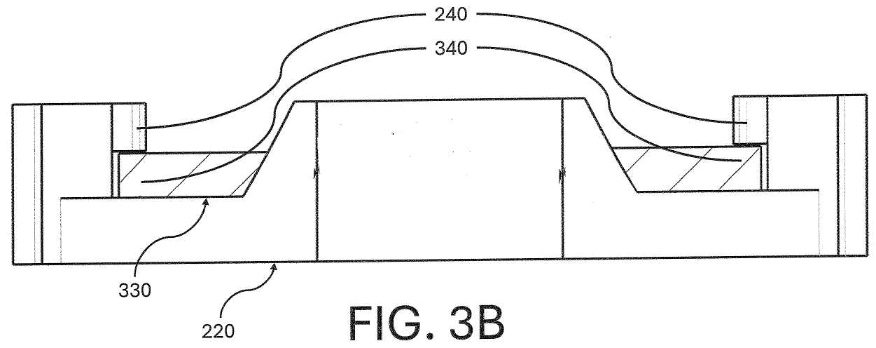

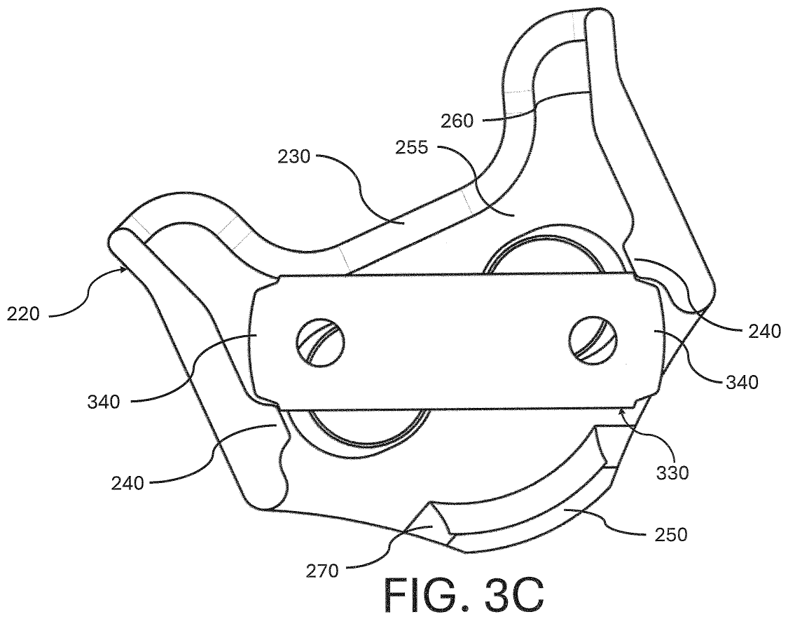

FIGS. 3A, 3B, and 3C show the interaction between cleat 220 and hub 330 as the components are moved from the engaged position (FIG. 3A) to the disengaged position (FIG. 3C). When engaged, FIG. 3A, cleat tabs 240 and hub tab 340 overlap each other. In other words, the hub tabs 340 are positioned underneath cleat tabs 240 within cleat tab slot 245 and above the main body 225 of cleat 220. In the engaged position, the opposing sides of hub tab 340 sit within cleat tab slots 245 reducing the movement of cleat 220, as shown in FIGS. 3A and 3B. To disengage cleat 220 from hub 330, the cleat is rotated until hub tab 340 fully rotates past and no longer sits in cleat tab slot 245 as shown in FIG. 3C. The amount of rotation required to move the hub tabs 340 out of the cleat tab slot 245 is referred to as the predetermined release angle which is decided by the width of cleat tab 240, cleat tab slot 245, and hub tabs 340. The zero angle where there is no float is shown in FIG. 3A. In some embodiments, the predetermined release angle shown in FIG. 3C is between about 12-40 degrees of rotation from the zero angle. Each cyclist naturally rotates their feet at different degrees of rotation during cycling. The range of degrees of rotation allows tunability between cyclists to determine the proper degree of rotation they desire to have their foot release. During the rotation, the cleat head 250 rotates within pedal insert slot 150, staying between pedal insert chamfer 130 and latch head 470.

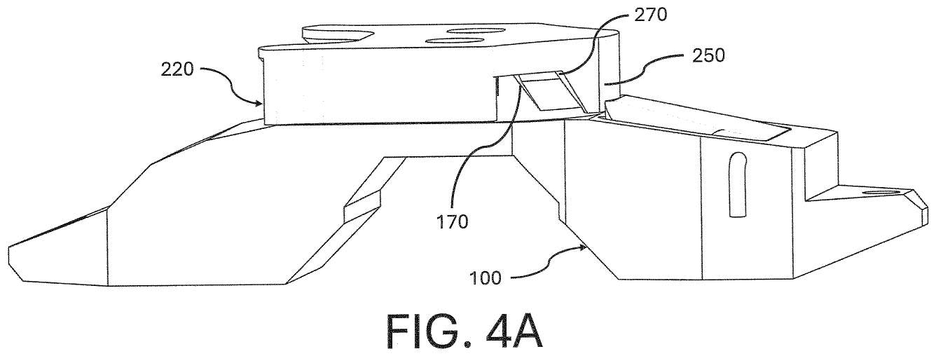

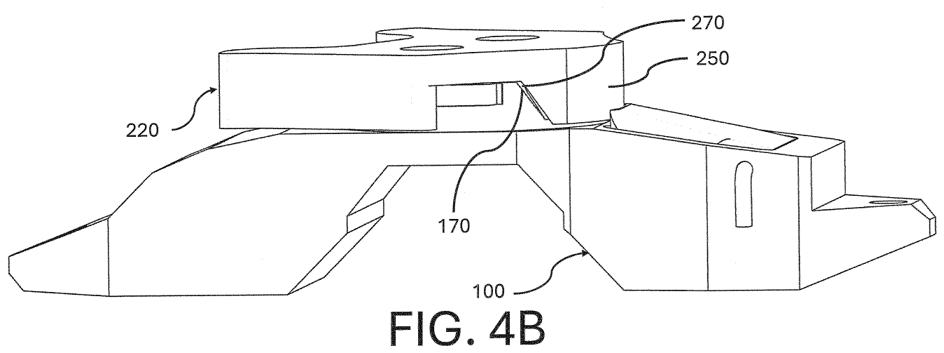

FIGS. 4A and 4B show a ramp assembly which helps release the cleat 220 from the pedal insert 100 by urging the cleat 220 upward away from the pedal insert 100 as it is rotated toward the predetermined release angle. FIG. 4A shows the clipless pedal assembly with the pedal insert 100 and cleat 220 in the engaged position wherein the assembly has close to zero angle or float. The cleat 220 can rotate freely around the pedal insert 100 with smooth contact along the pedal insert chamfer 130 and latch head 470, within the predetermined release angle. In other words, while the interference of the tabs 240, 340 prevents the cleat 220 from lifting upward away from the pedal insert 100 when the components are in the engaged position, the cleat 220 is still able to rotate relative to the pedal insert 100 without having to overcome any spring force since the release assembly for disengaging the cleat 220 from the pedal insert 100 does not use a spring.

FIG. 4B illustrates how the cleat 220 interacts with the pedal insert 100 during disengagement. The cleat 220 during disengagement acts as like a screw with zero pitch (no translational motion during rotation) until the ramps 170, 270 began to contact. Once the ramps 170, 270 began to contact the screw pitch becomes >0 (the rotation motion results in translational motion too). The ramps 170, 270 are designed to contact when the cleat 220 is almost fully disengaged from the pedal insert 100. During the contact, the ramps 170, 270 shear across each other's surface due to the rotation toque applied during disengagement of the cleat 220 from the pedal insert 100. The shear motion on ramps 170, 270 are translated to vertical motion (motion parallel to the axis of rotation) due to the angle at which the ramps are engaging. The ramps 170, 270 can be designed with an angle of 100-170 degrees. The change in degree determines the pitch of the screw mechanism of the cleat disengagement. The design of the ramps 170, 270 are to translate the rotational motion into a natural vertical caused by a rotational motion. The natural vertical motion caused from the ramps 170, 270 allows the cleat 220 to completely clear the pedal insert 100 without the cyclist's having to lift their foot themselves, allowing for a quick and ergonomic dismount of the cyclist's foot. The combination of the ramps 170, 270 vertical motion and the rotation from releasing the cleat 220 causes the cleat 220 to move in a diagonal motion away from the pedal insert 100 allowing the cyclists to have their foot in a good position for planting on the ground.

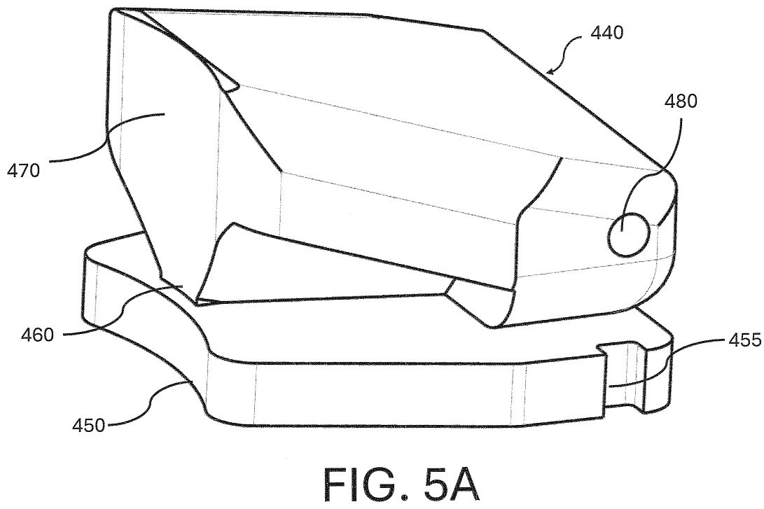

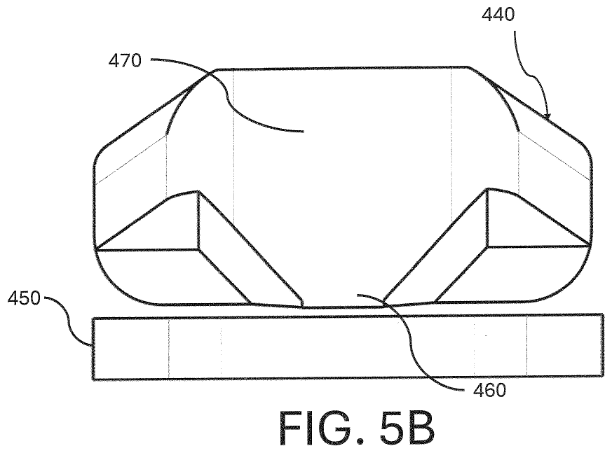

FIG. 5A and FIG. 5B shows a close up of latch spring 450 that sits within pedal insert blind opening 120 to support and provide constant force on latch 440. Latch spring 450 is compressed by latch 440 when cleat 220 is slid across the top towards full engagement, pushing latch 440 upwards to protrude from pedal insert 100. When cleat 220 has fully passed, holding cleat head 450 pinned between the flat end of latch 440 and the chamfered edge of the top protrusion on pedal insert 100. Latch 440 sits above the top of latch spring 450, held in by rod 550 at latch point of rotation 480 within the pedal insert blind opening 120. The top side of latch 440, FIG. 5B is flat and smooth as it is a main contact point for cleat head 450 to slide across during the engagement motion. As cleat head 250 slides across the top of latch 440, latch spring 450 is compressed by latch spring pressure point 460 until the top side of latch head 470 is level with pedal insert slot 150 (see FIG. 1E). In some embodiments the latch spring 450 is a metal coil spring. In other embodiments the latch spring 450 is made from a self-damping, elastomer-based polymer which requires minimal force to compress and remains ultra resilient over time. The elastomer-based polymer is more optimal than a mechanical spring due to the ability and tunability to work in tight spaces allowing for simplicity in the design. The width of the latch spring pressure points 460 effectively dictates the force required to compress the latch spring 450. A thinner latch spring pressure points 460 would require less force to compress latch spring 450; conversely, a wider latch spring pressure point 460 would require more force to compress latch spring 450. Once cleat head 250 has slid across the top of latch 440, latch spring 450 returns to its original position. Latch spring 450 causes latch 440 to shoot back up, and the top of latch head 470 prevents the back of cleat head 250 from disengaging by sliding backwards.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

1. A clipless bicycle pedal assembly comprising:
a pedal insert having a latch, a latch spring, a pedal insert slot, and a hub having a hub tab, wherein the latch is movable between a retracted position and an extended position and the latch spring is configured to urge the latch toward the extended position, and wherein the pedal insert slot is an opening between the latch and a portion of the pedal insert;
a cleat having a cleat head, a cleat body, a cleat tab, and cleat tab slot, wherein the cleat tab slot is an opening between the cleat body and the cleat tab and is configured to receive the hub tab;
wherein the cleat and the pedal insert have an engaged position wherein the cleat is attached to the pedal insert and a disengaged position wherein the cleat is not attached to the pedal insert;
wherein in the engaged position the pedal insert slot receives the cleat head and the cleat tab slot receives the hub tab.

2. The clipless bicycle pedal assembly of claim 1 wherein the pedal insert is configured to be attached to a bike pedal and the cleat is configured to be attached to a cycling shoe.

3. The clipless bicycle pedal assembly of claim 1 wherein in the engaged position the cleat tab interferes with the hub tab to keep the pedal insert attached to the cleat.

4. The clipless bicycle pedal assembly of claim 1 wherein the latch spring is an elastomer-based polymer.

5. The clipless bicycle pedal assembly of claim 1 wherein the cleat is configured to rotate relative to the pedal insert when the cleat and the pedal insert are in the engaged position.

6. The clipless bicycle pedal assembly of claim 1 wherein rotation of the cleat relative to the pedal insert causes movement from the engaged position to the disengaged position without encountering any spring force.

7. The clipless bicycle pedal assembly of claim 1 wherein in the engaged position the cleat and the pedal insert are configured to rotate relative to each other about an angle of rotation until the angle of rotation reaches a predetermined release angle wherein the cleat and the pedal insert are in the disengaged position.

8. The clipless bicycle pedal assembly of claim 7 wherein the predetermined release angle is between about 12-40 degrees of rotation from a zero angle.

9. The clipless bicycle pedal assembly of claim 7 wherein the cleat tab moves beyond the hub tab at the predetermined release angle.

10. The clipless bicycle pedal assembly of claim 7 wherein the hub tab is outside of the cleat tab slot at the predetermined release angle.

11. The clipless bicycle pedal assembly of claim 1 wherein the cleat further comprises a cleat ramp and the pedal insert further comprises a pedal insert ramp.

12. The clipless bicycle pedal assembly of claim 11 wherein the cleat ramp and the pedal insert ramp are configured to engage each other causing the cleat to move away from the pedal insert in a direction parallel to the axis of rotation as the cleat is rotated toward the predetermined release angle.

13. The clipless bicycle pedal assembly of claim 1 wherein the cleat further comprises a leading end having a cleat engagement chamfer and the pedal insert further comprises a pedal insert chamfer, the cleat engagement chamfer configured to engage the pedal insert chamfer as the cleat and the pedal insert move from the disengaged position to the engaged position to help direct the cleat onto the hub.

14. A clipless bicycle pedal assembly comprising:
a pedal insert having a latch, a latch spring, and a hub having a hub tab, wherein the latch is movable between a retracted position and an extended position and the latch spring is configured to urge the latch toward the extended position;
a cleat having a cleat head, a cleat body, a cleat tab, and cleat tab slot, wherein the cleat tab slot is an opening between the cleat body and the cleat tab configured to receive the hub tab;
wherein the cleat and the pedal insert have an engaged position wherein the cleat is attached to the pedal insert and a disengaged position wherein the cleat is not attached to the pedal insert;
wherein the latch is configured to limit longitudinal movement of the cleat when the cleat and the pedal insert are in the engaged position;
wherein the hub tab is configured to limit vertical movement of the cleat tab when the cleat and the pedal insert are in the engaged position;
wherein the cleat is configured to rotate relative to the pedal insert between a zero angle and a predetermined release angle wherein the hub tab moves out of the cleat tab slot.

15. The clipless bicycle pedal assembly of claim 14 wherein the cleat is configured to rotate relative to the pedal insert from the zero angle to the predetermined release angle without encountering any spring force.

16. The clipless bicycle pedal assembly of claim 14 wherein the cleat further comprises a cleat ramp and the pedal insert further comprises a pedal insert ramp, the cleat ramp and the pedal insert ramp are configured to engage each other causing the cleat to move away from the pedal insert in a direction parallel to the axis of rotation as the cleat is rotated toward the predetermined release angle.

17. A clipless bicycle pedal assembly comprising:
a pedal insert having a latch, a latch spring, a pedal insert ramp, and a hub having a hub tab, wherein the latch is movable between a retracted position and an extended position and the latch spring is configured to urge the latch toward the extended position;
a cleat having a cleat head, a cleat body, a cleat ramp, a cleat tab, and cleat tab slot, wherein the cleat tab slot is an opening between the cleat body and the cleat tab configured to receive the hub tab;
wherein the cleat and the pedal insert have an engaged position wherein the cleat is attached to the pedal insert and a disengaged position wherein the cleat is not attached to the pedal insert;
wherein the cleat ramp and the pedal insert ramp are configured to engage each other causing the cleat to move away from the pedal insert in a direction parallel to the axis of rotation as the cleat is rotated toward the predetermined release angle.

18. The clipless bicycle pedal assembly of claim 16 wherein rotation of the cleat relative to the pedal insert causes movement from the engaged position to the disengaged position without encountering any spring force.

19. The clipless bicycle pedal assembly of claim 16 wherein in the engaged position the cleat and the pedal insert are configured to rotate relative to each other about an angle of rotation until the angle of rotation reaches a predetermined release angle wherein the cleat and the pedal insert are in the disengaged position.

20. The clipless bicycle pedal assembly of claim 16 wherein the cleat further comprises a leading end having a cleat engagement chamfer and the pedal insert further comprises a pedal insert chamfer, the cleat engagement chamfer configured to engage the pedal insert chamfer as the cleat and the pedal insert move from the disengaged position to the engaged position to help direct the cleat onto the hub.
